(19) United States
(12) Patent Application Publication
(10) Pub. No.: US 2011/0084178 A1
(43) Pub. Date: Apr. 14, 2011

(54) CONDUIT HANGING DEVICE

(75) Inventors: Christoph WIEDNER, Feldkirch (AT); Mark Winkler, Hohenems (AT); Marc Nutzmann, Lindau (DE)

(73) Assignee: Hilti Aktiengesellschaft, Schaan (LI)

(21) Appl. No.: 12/899,899

(22) Filed: Oct. 7, 2010

(30) Foreign Application Priority Data
Oct. 8, 2009 (DE) 10 2009 045 484.5

(51) Int. Cl. F16L 3/08

(52) U.S. Cl. 248/62

(57) ABSTRACT

A conduit hanging device is disclosed. The device has a first clevis element which has a connection section and two branches separate from each other and a connection device for a hanging element. The device further includes a second clevis element which has a holder section for the conduit and two branches separate from each other. On each free end of a branch of the second clevis element a suspension section is provided, and on each branch of the first clevis element a holder opening as well as a suspension slot connecting to it are provided for the corresponding suspension section. Each of the suspension sections extends in a plane spanned by the corresponding branch of the second clevis element.

This application claims the priority of German Patent Document No. 10 2009 045 484.5, filed Oct. 8, 2009, the disclosure of which is expressly incorporated by reference herein.

### BACKGROUND AND SUMMARY OF THE INVENTION

The invention concerns a conduit hanging device for hanging a conduit from a structural component.

Such conduit hanging devices are provided in the field of installation technology, for example, for heating, ventilation, hot water, fresh water or wastewater installations, specifically in the U.S. for conduits, for example, tubes or channels, which, for example, are positioned on a rod-shaped hanging element that is fastened to the structural component, e.g., a ceiling. These conduit hanging devices are also known to a person skilled in the art by the term “clevis hanger.”

U.S. Patent Application Publication No. 2006/0180713 A1 discloses a conduit hanging device with a first U-shaped clevis element and a second U-shaped clevis element whose end areas of the branches each have a feed-through opening whereby two feed-through openings provided on both end areas for feeding through a connection element connecting the two clevis elements can be overlapped with each other. The first clevis element in a connection section connecting the branches has an additional feed-through opening through which the hanging element can be passed through and by means of two nuts can be fixed to it at the desired height. The second clevis element is pushed over the conduit to be hanged and by means of the connection element is fastened to the first clevis element fixed to the hanging element.

The disadvantage of this known solution is that the conduit hanging device has several separate parts and mounting the conduit to be hanged is time-consuming.

The company Tolco sells a conduit hanging device under the name “Ultra Clevis Hanger” for hanging a conduit from a structural component, which device has a first clevis element and a second clevis element that can be connected to it. The first clevis element has two branches, separate from each other, whose overlapping end sections form a connection section in which a bore is provided in each case as a connection device for the hanging element, whereby the bores can be overlapped with each other. The second clevis element has a holder section for the conduit as well as two separate branches, whereby on each free end of a branch of the second clevis element a suspension section angled away from the corresponding branch is provided. A holder opening as well as a suspension slot connected to it for the corresponding suspension section of the second clevis element are provided at each branch of the first clevis element. The one suspension section with the corresponding branch encloses an angle of approximately 135° so that it forms an articulation in the assembled state of the clevis elements around which articulation the second clevis element is mounted pivotably on the first clevis element. The other suspension section with the corresponding branch encloses an angle of approximately 90° so that it forms a seal of the conduit hanging device in the assembled state of the clevis elements.

The disadvantage of this known solution is that under load the connections between the first and the second clevis element are heavily stressed to bending, which results in low rigidity of the conduit hanging device.

It is the task of the invention to create a conduit hanging device to hang a conduit from a structural component which does not have the aforementioned advantages and which specifically has a better performance with respect to the power flow or the load absorption.

According to the invention, each suspension section extends in a plane spanned by the corresponding branch of the second clevis element.

The suspension section therefore substantially runs in the plane of the corresponding branch of the second clevis element which makes this simpler and therefore more economical to manufacture. Furthermore, the load on the connection in the main load direction occurs only axially in the direction of the branch, i.e., in the direction of the material thickness of the branch. The clevis elements are produced advantageously from a sheet, e.g., in a stamping/bending process. The suspension sections are stressed only minimally to bending, which can reduce the material thickness specifically of the second clevis element compared to a known second clevis element of a generic conduit hanging device. This also makes it possible to improve the rigidity of the inventive conduit hanging device and its cost effectiveness. Specifically with respect to a mass-produced product, as represented by such a conduit hanging device, cost-effective production is a substantial advantage. A suspension section or both suspension sections that with the plane spanned by the corresponding branch form an angle, e.g., in the range of +5° to −5°, are still seen as extending in the plane of the branch or lying within it.

In the assembled state of the clevis elements and at least under load, the suspension sections advantageously contact the corresponding inner wall of the corresponding branch of the first clevis element so that an advantageous power transfer is secured between the clevis elements.

Preferably, adjacent to at least one of the holder openings a locking device is provided on the first clevis element that prevents the unintentional release of the corresponding connection between the first and the second clevis element, for example, with respect to a movement of the second clevis element in the direction of the first clevis element. A locking device is advantageously provided on both holder openings on the first clevis element, which openings are advantageously facing each other and therefore do not protrude beyond the external contour of the conduit hanging device. The locking device advantageously comprises protrusions that further advantageously are formed on the corresponding branch of the first clevis element and especially advantageously protrude in the direction of the second clevis element.

Each branch of the first clevis element preferably has a first branch section and a second branch section connecting to it, running at an angle to the first branch section and facing the other branch of the first clevis element, whereby the holder openings for the suspension section of the second clevis element at least with respect to one of the branches is provided in the second branch section of the corresponding branch of the first clevis element and the suspension slot, connecting to it, extends along the first branch section of the corresponding branch of the first clevis element. Advantageously the first branch sections of the separated branches of the first clevis element run parallel to each other. This ensures a secure connection between the first and second clevis element in their assembled state, because at least one suspension section with respect to a movement of the second clevis element in the direction of the first clevis element strikes a section of the corresponding branch and thereby additionally prevents the unintentional release of the connection.

Preferably, the first clevis element has a connection section that connects the two branches of the first clevis element with each other at an end area turned away from the connection device, which makes the first clevis element and therefore the conduit hanging device have a stable form. Specifically with respect to a first clevis element manufactured from a sheet, this guarantees simple production.

Preferably, each branch of the first clevis element has an end section with a free end whereby these end sections can be overlapped with each other and whereby the connection device is provided in the overlapping end sections, which makes a simple and stable form of the conduit hanging device possible.

Preferably, the connection device comprises two elongated holes that are each provided in one of the end sections whose width each taper to the free end of the end sections and that can be overlapped with each other, so that the conduit hanging device can be fastened to hanging elements with various diameters. The more the end sections are overlapped with each other, the greater is the feed-through opening formed by the overlapping elongated holes through which the hanging element fastened to the structural component can be passed through. Advantageously, the branches of the first clevis element have a spring tension that forces them apart from each other so that edge sections of the elongated holes come into contact with the passed-through hanging element and therefore temporarily fixes the conduit hanging device to it. The elongated holes are advantageously formed through two bores with different diameters which overlap or intersect each other in certain areas. Alternatively, the elongated holes each have an end with a radius and adjacent to the free end of the corresponding end section an end with a smaller radius as well as a linear sidewall running between the sidewall.

Preferably, the connection device comprises a connection element positioned rotatably on the first clevis element with a threading section so that a height adjustment of a conduit hanging element fastened to the hanging element is possible. For a simple activation of the connecting element, the connecting element comprises advantageously a torque entrainment for a rotating tool. Further advantageously, the threading section is an internal threading positioned in a bore of the connecting element that enables a large adjustment range for adjusting the height. In addition, the connection element advantageously has a radially protruding, advantageously circumferential collar section or flange that for example is formed by a rim of an edge section of the connection element and that can be brought into contact with the connection section of the first clevis element. The collar section secures the connection element from being drawn through under load.

Preferably, a load distribution sheet is provided for the conduit that can be fastened to the holding section of the second clevis element via a holding device formed on the load distribution sheet. The load distribution sheet prevents the formation or damage, for example, of external insulation of a conduit as a result of voltage peaks that can occur with respect to an adjacent load transfer surface between the conduit and the holding section of the second clevis element. With the holding device, which advantageously enables a detachable fastening of the load distribution sheet, the load distribution sheet can be easily fastened to the holding section of the second clevis element and removed again from it.

The invention is further explained below by means of an embodiment.

### BRIEF DESCRIPTION OF THE DRAWINGS

FIG. 1 a conduit hanging device from one view;

FIG. 2 is the conduit hanging device in one perspective;

FIG. 3 is a magnified section according to detail III in FIG. 2;

FIG. 4 is a magnified section according to detail IV in FIG. 2;

FIG. 5 is the load distribution sheet in longitudinal view; and

FIG. 6 is a magnified section according to detail VI in FIG. 5.

### DETAILED DESCRIPTION OF THE DRAWINGS

In principle, the same parts with the same reference numbers are provided in the figures.

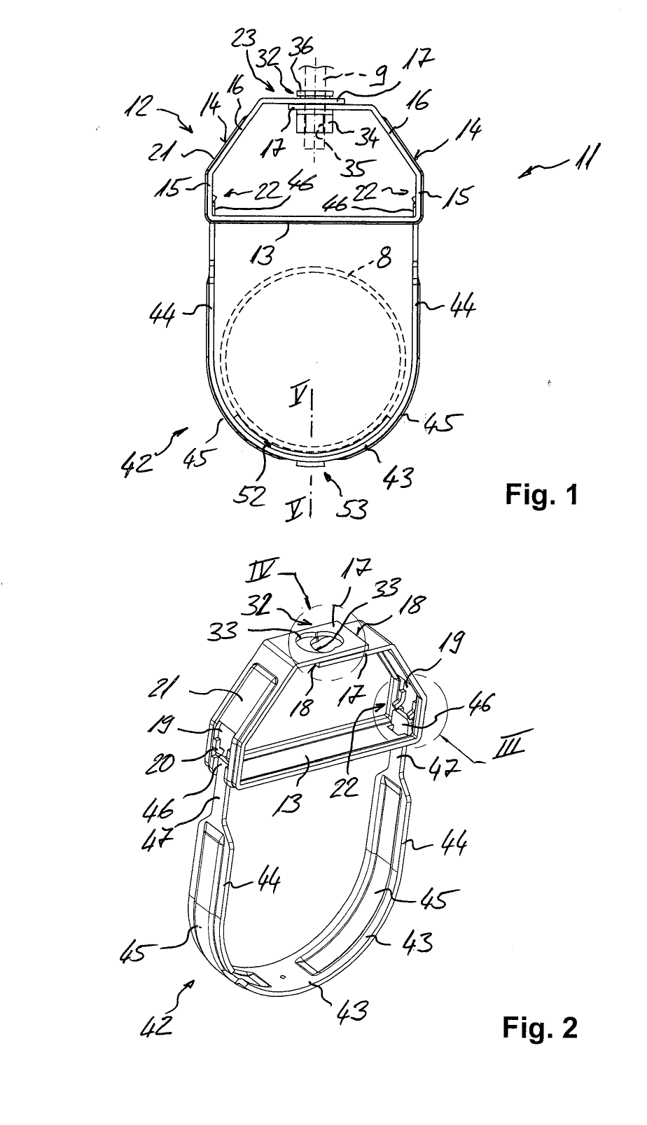

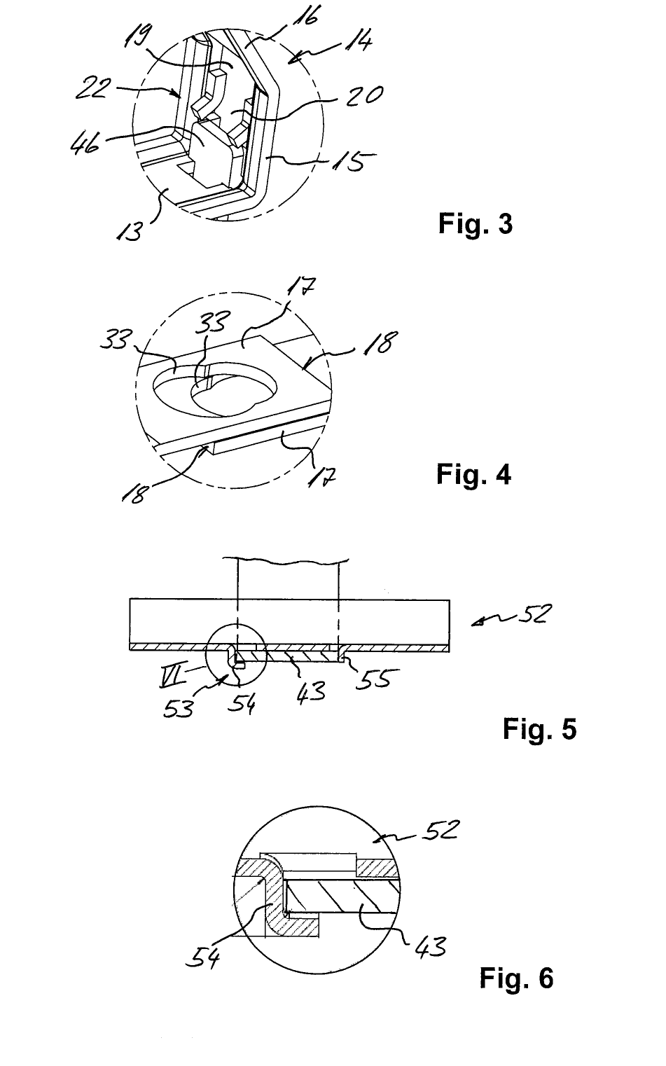

In FIGS. 1 to 6, a conduit hanging device 11 is depicted for hanging a conduit 8 from a structural component. The conduit hanging device 11 has a first clevis element 12 as an upper clevis and a second clevis element 42 connected to it as a lower clevis.

The first clevis element 12 is produced from a steel sheet in a stamping/bending process. The first clevis element 12 has a connection section 13 and two branches 14 protruding from the connection section 13. Each branch 14 has a first branch section 15 that substantially extends at a right angle from the connection section 13 and a second branch section 16 connecting to it, running at an angle to the first branch section 15, and facing toward the other branch 14. In addition, each branch has an end section 17 with a free end 18, whereby these end sections 17 can be overlapped with each other and form a connection section 23 in which a connection device 32 is provided in the overlapping end sections 17. The two branches 14 are connected to each other via the connection section 13 to an end area facing away from the connection device 32 and spring-elastic in the direction toward each other. For bracing the first clevis element 12, the connection section 13 has a ribbing 21 that extends in certain areas into the branches 14.

Adjacent to the transitional area between the first branch section 15 and the second section 16, each branch 14 in the second branch section 16 has a holder opening 19 to which a suspension slot 20 is connected in each case that extends along the first branch section 15 in the direction of the connection section 13. Adjacent to the holder openings 19, a locking device 22 is provided in each case on the first clevis element 12. The locking devices 22 are each formed from two nose sections separate from each other by the width of the suspension slot 20, which sections are formed from the corresponding branch 14 and extend at a slant in the direction of the connection section 13 and the opposing branch 14.

The connection device 32 comprises two elongated holes 33 that are each provided in one of the end sections 17 whose width in each case tapers to the free end 18 of the end sections 17 and that can be overlapped with each other. The elongated holes 33 are each formed from two bores with various diameters, which overlap in certain areas. Further, the connection device 32 comprises a connection element 34 positioned rotatably on the first clevis element 12, which element has a continuous bore with internal threading as threading section 35. The hanging element 9 with external threading, e.g., a threaded rod, can be screwed into the threading section 35 of the connection element 34. As a result of the rotatable mounting of the connection element 34, a conduit hanging device 11 positioned on the hanging element 9 can be adjusted for height or can be adjusted in its position relative to the longitudinal direction of the hanging element 9. The connection element 34 also has a radially protruding collar section 36, which is advantageously bordered, at one end.

To position the connection element 34 on the first clevis element 12, the branches 14 are pressed together and then the connection element 34 is introduced to the enlarged feed-through opening. Upon release of the branches 14, the connection element 34 is held clampingly but still rotatably in the end sections 17.

The second clevis element 42 is likewise formed substantially in a U-shape and is produced from a steel sheet in a stamping/bending process. The second clevis element 42 has a partially circular holding section 43 for the conduit 8 as well as two branches 44 separate from each other and each connecting to the holding section 43. To reinforce the second clevis element 42, two ribs 45 are provided that each extend starting from a transitional area of the holding section 43 and the branches 44 in certain areas to the holding section 43 and in certain areas to the branch 44 connecting to it.

At the free end of each branch 44 of the second clevis element 42, a suspension section 46 is provided that is formed by a tapered section 47, separate from the free end, of the corresponding branch 44. Each of the suspension sections 46 extends in a plane spanned by the corresponding branch 44.

To hang the conduit 8 with the inventive conduit hanging device 11, first the first clevis element 12 is fastened to the hanging element 9 via the connection device 32. Then, a suspension section 46 of the second clevis element 42 is passed through the holder opening 19 in the branch 14 of the first clevis element 12 and guided along the hanging slot 20 connecting to it. The suspension section 46 slips over the provided locking device 22 adjacent to the corresponding holder opening 19. In this position, the second clevis element 42 is positioned pivotably on the first clevis element 12 and the conduit 8 can be inserted into the second clevis element 42.

Then the second clevis element 42 is pivoted in the direction of the first clevis element 12 and the suspension section 46 of the other branch 44 is passed through the other holder opening 19 of the first clevis element 12 and guided along the suspension slot 20 connecting to it. The suspension sections 46 in this state of the conduit hanging device 11 lie flat on the inner wall of the corresponding branch of the first clevis element 12.

On the holding section 43 of the second clevis element 42, a load distribution sheet 52 is provided for the conduit 8 that can be fastened via a holding device 53, formed on the load distribution sheet 52, to it. The holding device 53 comprises a hook section 54 and a holding section 55 separated from it. The distance between the holder formed by the hook section 54 and the holding section 55 substantially corresponds to the width of the corresponding section of the holding section 43 so that the load distribution sheet 52 if needed can simply be plugged into or clipped onto the holding section 43.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A conduit hanging device, comprising:
a first clevis element which has a connection section and two branches;
a second clevis element which has a holder section and two branches, wherein a respective suspension section is included at a free end of each of the two branches of the second clevis element;
wherein a respective holder opening and a suspension slot is included in each of the two branches of the first clevis element, wherein a respective suspension section is receivable in a respective holder opening and suspension slot;
and wherein the suspension sections extend in a plane spanned by respective branches of the second clevis element.

2. The conduit hanging device according to claim 1, wherein adjacent to at least one of the holder openings a locking device is provided on the first clevis element.

3. The conduit hanging device according to claim 1, wherein each branch of the first clevis element has a first branch section and a second branch section running at an angle to the first branch section, wherein the holder opening is included in the second branch section and the suspension slot extends along the first branch section.

4. The conduit hanging device according to claim 1, wherein the connection section connects the two branches of the first clevis element at an end area facing away from a connection device.

5. The conduit hanging device according to claim 1, wherein each of the two branches of the first clevis element has an end section with a free end, wherein the end sections are overlap able with each other, and wherein a connection device is provided in overlapping end sections.

6. The conduit hanging device according to claim 5, wherein the connection device includes elongated holes provided in the end sections of the two branches, wherein the elongated holes have a width that tapers to a respective free end of the end sections, and wherein the elongated holes are overlappable with each other.

7. The conduit hanging device according to claim 1, further comprising a connection device including a connection element positioned rotatably on the first clevis element with a threading section.

8. The conduit hanging device according to claim 1, wherein a load distribution sheet is fastened to the holder section of the second clevis element via a holding device formed on the load distribution sheet.
